(19) United States
(12) Patent Application Publication
(10) Pub. No.: US 2004/0094268 A1
(43) Pub. Date: May 20, 2004

(54) Oxidation inhibitor for wet etching processes

(76) Inventor: Justin K. Brask, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/301,038

(22) Filed: Nov. 20, 2002

(51) Int. Cl. C03C 25/68; C23F 1/00

(52) U.S. Cl. 156/345.11; 216/90

(57) ABSTRACT

Methods for etching a target conducted in an etching solution that is substantially free of entrained oxygen gas, thereby inhibiting oxidation of an etching target, and apparatus for achieving the same. An etching solution that is substantially free of entrained oxygen gas is achieved by driving off the entrained oxygen gas with an inert gas.

### BACKGROUND OF THE INVENTION

1. Field of the Invention

The present invention relates generally to the manufacture of microelectronic devices. In particular, the present invention relates to using a wet etch technique and apparatus for the formation of structures within microelectronic dice, wherein the wet etch solution is substantially free of entrained oxygen gas.

2. State of the Art

In the microelectronics industry, etching is used extensively to remove selected portions of a substrate (such as a silicon substrate), to remove photoresist, to clean, and to perform other functions generally related to the fabrication of microelectronic devices. More specifically, wet etching is a widely used tool for the manufacture of microelectronic devices, wherein an etching target is exposed to at least one reagent material, called an etchant. The etching target is generally immersed in a chemical bath containing the etchant for a specified period of time. During the immersion, at least one chemical reaction occurs which substantially achieves the desired etching result, as will be understood by those skilled in the art.

Such wet etching may be conducted in etching solutions containing a basic etchant, such as alkali metal hydroxides (such as potassium hydroxide (KOH)), hydrazine, EDP (Ethylene diamine—Pyrocatechol—Water), and ammonium hydroxide (such as tetra methyl ammonium hydroxide (TMAH)) solutions. All of these solutions show similar etching characteristics, but some have specific drawbacks when compared to each other. For example, metal impurities from the alkali metal hydroxides cause contamination, which renders them incompatible with MOS and CMOS processing. Hydrazine is a dangerous, flammable liquid. EDP is also incompatible with MOS and CMOS processing. Thus, on balance, ammonium hydroxides are generally preferred etchants.

One characteristic of ammonium hydroxide etching solutions is that they do not significantly etch silicon dioxide. Although this is an advantage in that silicon dioxide can be used as an etch mask, it is a disadvantage when etching a silicon-containing substrate (or such material), if oxygen gas diffuses into the etching solution. When oxygen gas diffuses into the etching solution, the entrained oxygen gas competes with the etchant in reacting with the silicon-containing substrate. Thus, during the etching of the silicon, a layer of silicon dioxide (hereinafter “oxide”) can form over the etch area from the reaction of the silicon and the oxygen gas, which halts the etching process.

Generally, oxygen gas diffuses into the solution because the wet etching process is conducted in the open atmosphere. To avoid this problem, the etching process must be performed with fresh etching solution, must have a blanket of inert gas above the etching solution, must be conducted in a closed environment, or must be etched with a separate etching solution or gas to break through the oxide after it has formed, then continue the previous etching process. However, even fresh solutions oxygenate in an open environment, an inert gas blanket is not effective of all cases, closed environments can be expensive and do not lend themselves to high speed processing, and having to use a separate etching solution or gas to break through the oxide adds processing time and cost.

Therefore, it would be advantageous to develop an apparatus and methods for etching silicon in an open atmosphere while preventing the diffusion of oxygen gas into the etching solution.

### BRIEF DESCRIPTION OF THE DRAWINGS

While the specification concludes with claims particularly pointing out and distinctly claiming that which is regarded as the present invention, the advantages of this invention can be more readily ascertained from the following description of the invention when read in conjunction with the accompanying drawings in which:

FIG. 1 is a schematic view of a wet etching apparatus, according to the present invention;

FIG. 2 is a schematic view of the wet etching apparatus of FIG. 1 having entrained oxygen gas in a wet etching solution of the wet etching apparatus, according to the present invention;

FIG. 3 is a schematic view of the wet etching apparatus of FIG. 2 having inert gas bubbled through the wet etching solution, according to the present invention;

FIG. 4 is a schematic view of the wet etching apparatus of FIG. 3, wherein the inert gas drives off the entrained oxygen gas, according to the present invention; and

FIG. 5 is a schematic view of the wet etching apparatus of FIG. 4 having a silicon-containing etching target immersed in the wet etching solution.

### DETAILED DESCRIPTION OF THE ILLUSTRATED EMBODIMENT

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein, in connection with one embodiment, may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

The present invention includes apparatus and methods for etching silicon-containing elements during the fabrication of microelectronic dice. The etching is conducted in an etching solution that is substantially free of entrained oxygen gas, thereby inhibiting oxidation of an etching target. This is achieved by driving off any entrained oxygen gas within the etching solution with an inert gas.

It is understood that the term “etch” and “etching” includes, but is not limited to, removing selected portions of a substrate (such as a silicon-containing substrate), removing of selected material areas, cleaning selected materials, and the like.

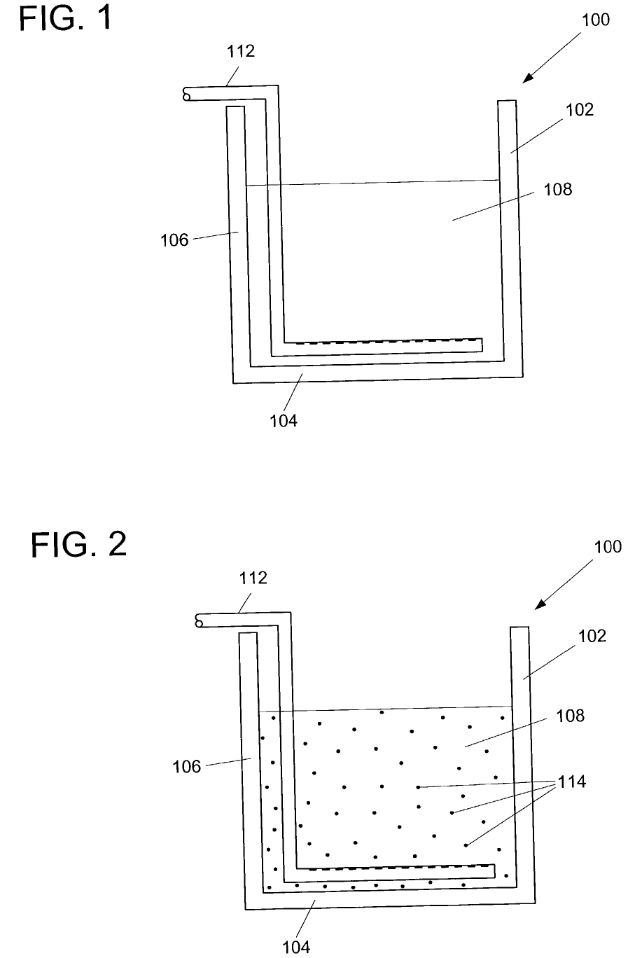

FIG. 1 illustrates a wet etching apparatus 100 according to the present invention. The wet etching apparatus 100 includes an open solution chamber 102 comprising a bottom side 104 and at least one vertical side 106, wherein the open solution chamber 102 has a wet etching solution 108 disposed therein. The wet etching solution 108 may include, but is not limited to, ammonium hydroxide, tetramethyl ammonium hydroxide, tetraethyl ammonium hydroxide, and tetra(alkyl)ammonium hydroxides. In one embodiment, the wet etching solution 108 comprises an aqueous solution of ammonium hydroxide, tetramethyl ammonium hydroxide, tetramethyammonium hydroxide, and/or a tetra(alkyl)ammonium hydroxide in a concentration of between about 5 and 50% by volume and may be maintained at an etch temperature between about 10 and 90 degrees Celsius (the temperature regulation device is not shown). The wet etching apparatus 100 further includes an inert gas feed line 112. A portion of the inert gas feed line 112 is preferably located proximate the solution chamber bottom side 104.

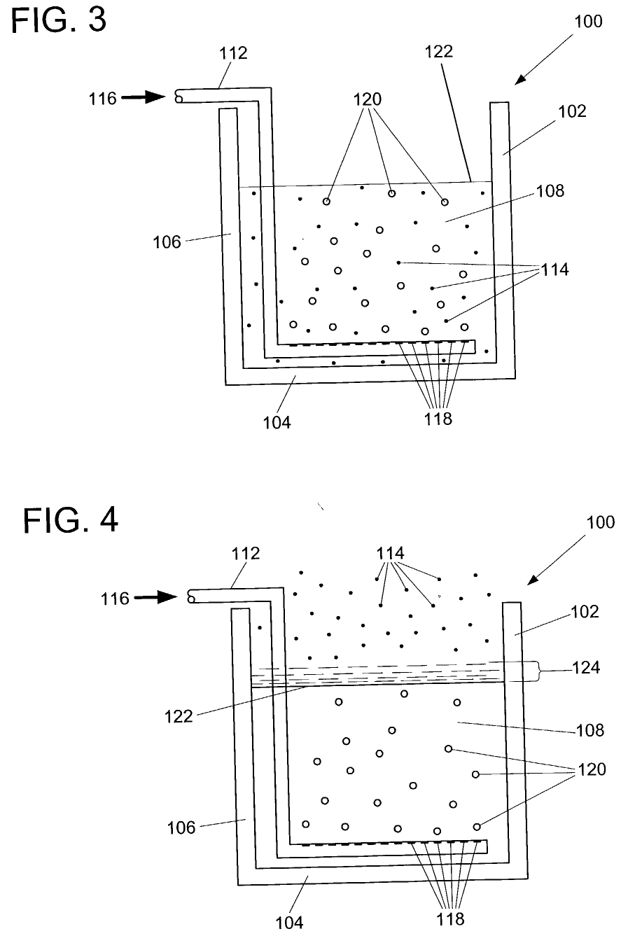

In one embodiment of the present invention, the wet etching solution 108 has entrained oxygen gas (shown as dots 114) dispersed therein, as illustrated in FIG. 2. An inert gas (shown as arrow 116) flows through the inert gas feed line 112, as illustrated in FIG. 3. In the portion of the inert gas feed line 112 proximate the solution chamber bottom side 104, the inert gas feed line 112 may have at least one outlet 118 to disperse the inert gas 116 through the wet etching solution 108 in the form of inert gas bubbles 120, which exits the wet etching solution 108 from an exposed surface 122 thereof, as also illustrated in FIG. 3. It is, of course, understood that a variety of devices could be configured on the inert gas feed line 112 to efficiently disperse the inert gas 116 within the wet etching solution 108, as will be clear to those skilled in the art.

The inert gas bubbles 120 drive off the entrained oxygen gas 114, as shown in FIG. 4 (i.e., the solution becomes saturated with the inert gas). Furthermore, the inert gas 116 can form a boundary layer 124 proximate an exposed surface 122 of the wet etching solution 108, which substantially prevents oxygen gas 114 from returning to the wet etching solution 108 during the etching process. The inert gas 116 can be any gas that will not significantly affect the etching process, which may include, but is not limited to, nitrogen (preferred) and noble gases (i.e., helium, neon, argon, krypton, and xenon).

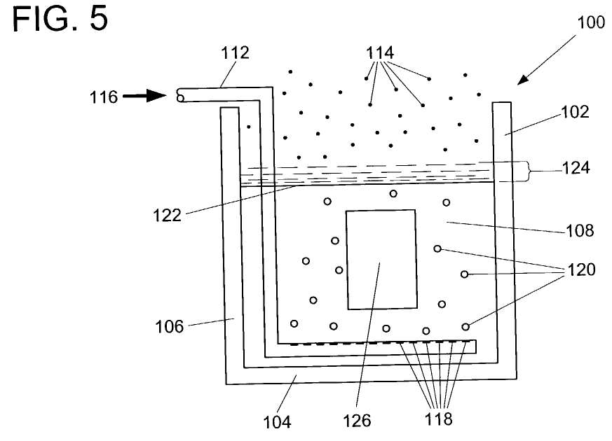

FIG. 5 illustrates an etching target 126, such as a silicon-containing etching target, immersed into the wet etching solution 108. By substantially removing the entrained oxygen gas 114 (see FIG. 2) from the wet etching solution 108, competitive oxidation of the silicon-containing etching target 126 by the entrained oxygen gas 114 is substantially eliminated. Preferably, the inert gas 116 is continuously delivered to the wet etching solution 108 during the etching process.

It is, of course, understood that the etching target 126 may be any target that is prone to oxidation that would affect an etching process. However, it is contemplated that the etching system of the present invention can be advantageously utilized in the fabrication of metal transistor gates, silicon-on-insulator structures, and tri-gate synthesis, as will be understood to those skilled in the art.

Thus, it can be seen that the present invention can both regenerate an aged etching solution (i.e., an etching solution saturated with entrained oxygen gas) by driving out entrained oxygen gas from the etching solution prior to etching and prevent oxygen gas entrainment/contamination during the etching process.

Having thus described in detail embodiments of the present invention, it is understood that the invention defined by the appended claims is not to be limited by particular details set forth in the above description, as many apparent variations thereof are possible without departing from the spirit or scope thereof.

What is claimed is:

1. An apparatus, comprising:
an open solution chamber having a bottom side;
an etching solution disposed within said open solution chamber; and
an inert gas dispersed through said etching solution.

2. The apparatus of claim 1, wherein said etching solution comprises at least one etchant selected from the group consisting of ammonium hydroxide, tetramethyl ammonium hydroxide, tetraethyl ammonium hydroxide, and tetra(alkyl)ammonium hydroxides.

3. The apparatus of claim 2, wherein said etching solution comprises an aqueous solution with said at least one etchant in a concentration of between about 5 and 50% by volume.

4. The apparatus of claim 3, wherein said etching solution is at an etch temperature between about 10 and 90 degrees Celsius.

5. The apparatus of claim 3, wherein said inert gas is selected from a group consisting of nitrogen, helium, neon, argon, krypton, and xenon.

6. The apparatus of claim 1, further comprising an inert gas feed line, wherein at least a portion of said inert gas feed line is positioned proximate said open solution chamber bottom side.

7. The apparatus of claim 6, wherein said portion of said inert gas feed line includes at least one outlet.

8. A method of etching a target, comprising:
providing an open solution chamber having a bottom side;
disposing an etching solution in said open solution chamber;
dispersing an inert gas through said etching solution; and
introducing said target into said etching solution.

9. The method of claim 8, wherein introducing said target into said etching solution comprises introducing a silicon-containing target into said etching solution.

10. The method of claim 8, wherein disposing said etching solution in said open solution chamber comprises disposing said etching solution having at least one etchant selected from the group consisting of ammonium hydroxide, tetramethyl ammonium hydroxide, tetraethyl ammonium hydroxide, and tetra(alkyl)ammonium hydroxides in said open solution chamber.

11. The method of claim 10, wherein disposing said etching solution in said open solution chamber comprises disposing an aqueous solution with at least one etchant in a concentration of between about 5 and 50% by volume.

12. The method of claim 11, further comprising maintaining said etching solution at an etch temperature between about 10 and 90 degrees Celsius.

13. The method of claim 8, wherein dispersing said inert gas through said etching solution comprises bubbling said inert gas through said etching solution.

14. The method of claim 8, wherein dispersing said inert gas through said etching solution comprises dispersing an inert gas selected from a group consisting of nitrogen, helium, neon, argon, krypton, and xenon through said etching solution.

15. The method of claim 14, wherein dispersing said inert gas through said etching solution further comprises providing an inert gas feed line, wherein at least a portion of said inert gas feed line is positioned proximate said open solution chamber bottom side and delivering said inert gas through said inert gas feed line.

16. A method of purging an etching solution of entrained oxygen gas, comprising:
providing a open solution chamber having a bottom side;
disposing an etching solution in said open solution chamber, wherein said etching solution includes entrained oxygen gas therein; and
dispersing an inert gas through said etching solution.

17. The method of claim 16, wherein disposing said etching solution in said open solution chamber comprises disposing said etching solution having at least one etchant selected from the group consisting of ammonium hydroxide, tetramethyl ammonium hydroxide, tetraethyl ammonium hydroxide, and tetra(alkyl)ammonium hydroxides in said open solution chamber.

18. The method of claim 17, wherein disposing said etching solution in said open solution chamber comprises disposing an aqueous solution with at least one etchant in a concentration of between about 5 and 50% by volume.

19. The method of claim 16, wherein dispersing said inert gas through said etching solution comprises bubbling said inert gas through said etching solution.

20. The method of claim 16, wherein dispersing said inert gas through said etching solution comprises dispersing an inert gas selected from a group consisting of nitrogen, helium, neon, argon, krypton, and xenon through said etching solution.

21. The method of claim 16, wherein dispersing said inert gas through said etching solution further comprises providing an inert gas feed line, wherein at least a portion of said inert gas feed line is positioned proximate said open solution chamber bottom side and delivering said inert gas through said inert gas feed line.
